(19) United States
(12) Patent Application Publication
(10) Pub. No.: US 2024/0152984 A1
(43) Pub. Date: May 9, 2024

(54) INFORMATION PROCESSING APPARATUS AND INFORMATION PROCESSING METHOD

(71) Applicant: ZOZO, Inc., Chiba-shi (JP)

(72) Inventors: Tsuyoshi IETA, Chiba-shi (JP); Shunsuke Minemura, Chiba-shi (JP)

(73) Assignee: ZOZO, Inc., Chiba-shi (JP)

(21) Appl. No.: 18/413,316

(22) Filed: Jan. 16, 2024

Related U.S. Application Data
(63) Continuation of application No. PCT/JP2022/027899, filed on Jul. 15, 2022.

(30) Foreign Application Priority Data
Jul. 29, 2021 (JP) 2021-124741

(51) Int. Cl. G06Q 30/0601

(52) U.S. Cl. CPC G06Q 30/0621

(57) ABSTRACT

Evaluation of a footwear size in consideration of foot development is properly performed. An information processing apparatus includes an acquisition section, a determination section, and a provision section. The acquisition section acquires attribute information of a user who has purchased footwear in a size suitable for the foot development. The determination section determines information for evaluating the size of the purchased footwear based on an attribute of the user included in the attribute information acquired by the acquisition section. The provision section provides information for proposing footwear in a size suitable for the foot development based on an evaluation result based on the information determined by the determination section.

### CROSS REFERENCE TO RELATED APPLICATIONS

This application is a continuation of International Patent Application No. PCT/JP2022/027899, having an international filing date of Jul. 15, 2022, which designated the United States, the entirety of which is incorporated herein by reference. Japanese Patent Application No. 2021-124741 filed on Jul. 29, 2021 is also incorporated herein by reference in its entirety.

### BACKGROUND OF THE INVENTION

Conventionally known techniques propose articles such as clothing or footwear suitable for users. For example, Japanese Patent No. 5256362 discloses a conventional technique proposes a size of a specific product suitable for a user based on evaluation results of sizes of the specific product by other users.

Unfortunately, conventional techniques fail to properly evaluate a footwear size in consideration of foot development.

### BRIEF DESCRIPTION OF THE DRAWINGS

FIG. 1 is a diagram illustrating a configuration example of an information processing system according to an embodiment.

FIG. 2 is a diagram illustrating an example of information processing according to the embodiment.

FIG. 3A is a table illustrating an example of statistical data of a male foot development pattern according to age.

FIG. 3B is a table illustrating an example of statistical data of a female foot development pattern according to age.

FIG. 4 is a diagram illustrating a configuration example of a terminal apparatus according to the embodiment.

FIG. 5 is a diagram illustrating a configuration example of an information processing apparatus according to the embodiment.

FIG. 6 is a table illustrating an example of an evaluation result storage section according to the embodiment.

FIG. 7 is a table illustrating an example of a measurement information storage section according to the embodiment.

FIG. 8 is a table illustrating an example of a development pattern storage section according to the embodiment.

FIG. 9 is a diagram illustrating a configuration example of a management server according to the embodiment.

FIG. 10 is a table illustrating an example of a product information storage section according to the embodiment.

FIG. 11 is a flowchart illustrating an example of information processing according to the embodiment.

FIG. 12 is a diagram illustrating a hardware configuration of an example of a computer that implements functions of the information processing apparatus.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided an information processing apparatus comprising at least one processor or circuit comprising:
an acquisition section configured to acquire attribute information of a user that has purchased footwear in a size suitable for foot development;
a determination section configured to determine information for evaluating the size of the purchased footwear based on an attribute of the user included in the attribute information acquired by the acquisition section; and
a provision section configured to provide information for proposing footwear in a size suitable for the foot development based on an evaluation result based on the information determined by the determination section.

In accordance with one of some embodiments, there is provided an information processing method executed by a computer, the method comprising:
an acquisition step for acquiring attribute information of a user that has purchased footwear in a size suitable for foot development;
a determination step for determining information for evaluating the size of the purchased footwear based on an attribute of the user included in the attribute information acquired in the acquisition step; and
a provision step for providing information for proposing footwear in a size suitable for the foot development based on an evaluation result based on the information determined in the determination step.

Exemplary embodiments are described below. Note that the following exemplary embodiments do not in any way limit the scope of the content defined by the claims laid out herein. Note also that all of the elements described in the present embodiment should not necessarily be taken as essential elements

A detailed mode (hereinafter referred to as an “embodiment”) for implementing an information processing apparatus, an information processing method, and an information processing program according to the present disclosure is described below with reference to the drawings. However, this embodiment does not constitute any limitation to the information processing apparatus, the information processing method, and the information processing program according to the present disclosure. In addition, identical sections in embodiments below are denoted by identical reference signs, and duplicate description is omitted.

### Embodiment

### 1. Configuration of Information Processing System

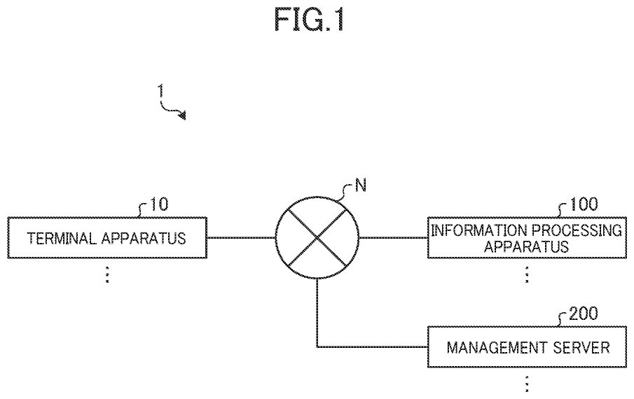

An information processing system 1 shown in FIG. 1 is described. As shown in FIG. 1, the information processing system 1 includes a terminal apparatus 10, an information processing apparatus 100, and a management server 200. The terminal apparatus 10, the information processing apparatus 100, and the management server 200 are communicably connected by wired or wireless via a predetermined communication network (network N). FIG. 1 is a diagram illustrating a configuration example of the information processing system 1 according to the embodiment. The information processing system 1 shown in FIG. 1 may include a plurality of terminal apparatuses 10, a plurality of information processing apparatuses 100 and a plurality of management servers 200.

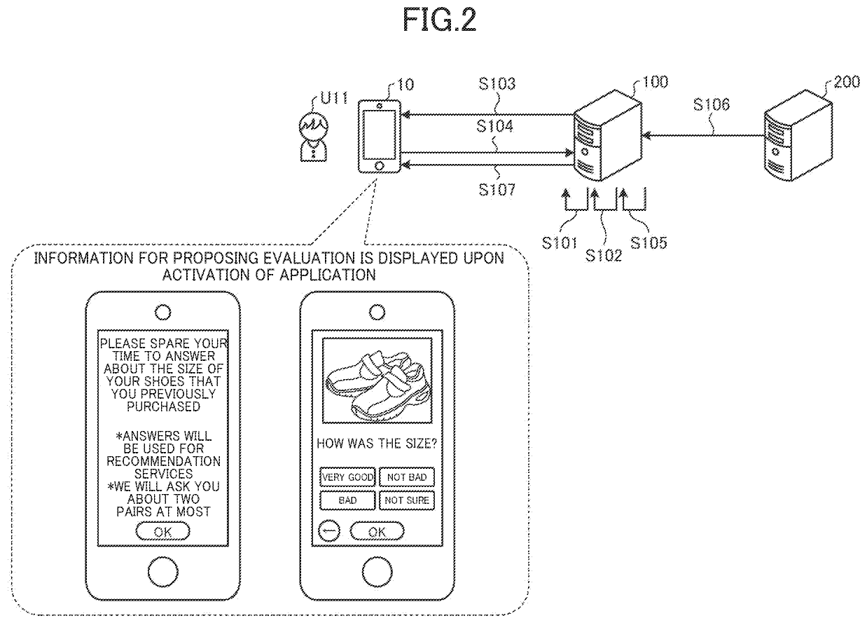

The terminal apparatus 10 is an information processing apparatus used by a user. The terminal apparatus 10 may be any type of apparatus if it can implement processing according to the embodiment. The terminal apparatus 10 may be an apparatus such as a smartphone, a tablet terminal, a notebook computer, a desktop computer, a mobile phone, or a PDA. In an example shown in FIG. 2, the terminal apparatus 10 is a smartphone.

For example, the terminal apparatus 10 is a smart device such as a smartphone and a tablet, and is a portable terminal apparatus that can communicate with an arbitrary server apparatus via a wireless communication network of 3rd generation (3G), long term evolution (LTE) or the like. The terminal apparatus 10 may include a screen such as a liquid crystal display having a touch panel function so as to receive various operations from the user, such as tap operation, slide operation, or scroll operation by a finger, a stylus, or the like on displayed data such as content.

In FIG. 2, the terminal apparatus 10 is used by a user U11. In the following description, the terminal apparatus 10 may be referred to as the user U11. That is, the user U11 can be read as the terminal apparatus 10 in the following description.

The information processing apparatus 100 is an information processing apparatus for properly evaluate a footwear size in consideration of foot development, and is implemented, for example, by a server apparatus or a cloud system. For example, the information processing apparatus 100 has a function of determining information for evaluating a size of purchased footwear based on a user attribute (e.g., age or sex) included in attribute information of the user who has purchased the footwear in the size suitable for the foot development.

The management server 200 is an information processing apparatus for managing a predetermined online mall that provides target footwear proposed by the information processing apparatus 100, and is implemented, for example, by a server apparatus or a cloud system. For example, the management server 200 has a function of providing information on the footwear provided at the predetermined online mall. Furthermore, the management server 200 may be an information processing apparatus for managing respective physical stores that provide the target footwear proposed by the information processing apparatus 100. For example, the management server 200 may have a function of providing information on the footwear provided at the respective physical stores. In the following embodiment, the footwear provided by the information processing apparatus 100 may be any type of footwear. For example, the footwear may be sneakers, sandals, boots, pumps, dress shoes, running shoes, or the like.

In FIG. 1, the terminal apparatus 10 and the information processing apparatus 100 are configured as separate apparatuses. However, the terminal apparatus 10 and the information processing apparatus 100 may be configured integrally. In addition, in FIG. 1, the information processing apparatus 100 and the management server 200 are configured as separate apparatuses. However, the information processing apparatus 100 and the management server 200 may be configured integrally.

### 2. Example of Information Processing

FIG. 2 is a diagram illustrating an example of information processing of the information processing system 1 according to the embodiment. In FIG. 2, a proposal is made to the user U11 via the terminal apparatus 10. In the following embodiment, the processing for proposing the footwear suitable for the foot development of the user U11 is described. The footwear suitable for the foot development of the user U11 is footwear presumed not to cause any discomfort such as that the footwear is too loose, too tight, or painful, or that a particular part protrudes from (comes out of) the footwear. The discomfort is not limited to discomfort from a viewpoint of the user U11, but may be discomfort from a viewpoint of a third party who sees the user U11 wearing the footwear, for example. Furthermore, in the following embodiment, the processing for determining the information for evaluating the size of the footwear purchased for the user U11 is described, and the evaluation is made through a questionnaire, for example.

The information processing apparatus 100 acquires attribute information of the user U11 who has purchased the footwear in the size suitable for the foot development (step S101). The attribute information of the user U11 is the attribute information at the time when the user U11 has purchased the footwear, for example. For example, when the age at the time of purchase is 15 years, the attribute information of the user U11 includes age information of 15 years. The footwear in the size suitable for the foot development may be the footwear proposed by the information processing apparatus 100. The processing for proposing the footwear in the size suitable for the foot development is described later.

Meanwhile, there is a case that the user U11 is a child and a user who purchases the footwear using the terminal apparatus 10 is a parent of the user U11, for example. Accordingly, the footwear is presumed to be purchased for the user U11. The step S101 can be read, as appropriate, as that the information processing apparatus 100 acquires the attribute information of the user U11 who has a predetermined relationship with the user who has purchased the footwear in the size suitable for the foot development. Accordingly, the user having the predetermined relationship with the user U11 is hereinafter referred to as a “related user” as appropriate.

The information processing apparatus 100 determines information for evaluating the size of the purchased footwear based on the attribute of the user U11 (step S102). For example, the information processing apparatus 100 determines a timing to propose evaluation as the information for evaluating the size of the purchased footwear. Furthermore, for example, the information processing apparatus 100 determines proposal content for proposing the evaluation as the information for evaluating the size of the purchased footwear. Furthermore, for example, the information processing apparatus 100 determines evaluation weighting according to the attribute as the information for evaluating the size of the purchased footwear. Each of these cases is described in detail below.

The following describes the case that the information processing apparatus 100 determines the timing to propose the evaluation. When the user U11 is a child, since the development of the child's feet has not stopped yet, it is presumed that a proper evaluation may not be obtained if the evaluation is made at the same timing as a timing for an adult. Thus, for example, even if the evaluation at a timing of remeasurement is appropriate in an adult case, the evaluation at a timing immediately after arrival of a product, the footwear, after purchase may be better in a child case.

When the attribute of the user U11 meets a predetermined condition, for example, the information processing apparatus 100 determines a timing when the user U11 has re-measured the feet (e.g., while measurement information of the feet is calculated) as the timing to propose the evaluation. For example, this applies to a case that the age of the user U11 is equal to or higher than a predetermined threshold (e.g., 20 years or older). This is because it is presumed that the evaluation of the footwear size does not change even if the evaluation is not made immediately after the purchase since the foot development of the adult is slower than the foot development of the child or has stopped, and that an answer is easy to obtain while the measurement information of the feet is calculated (while there is nothing else to do). On the contrary, when the attribute of the user U11 does not meet the predetermined condition, the information processing apparatus 100 may decide not to determine the timing when the user U11 has re-measured the feet as the timing to propose the evaluation. For example, this applies to a case that the age of the user U11 is lower than the predetermined threshold (e.g., younger than 20 years). Meanwhile, it is presumed that the purchased footwear has already arrived at a timing when the user U11 accesses the predetermined online mall that provides the purchased footwear again after the purchase. When the attribute of the user U11 does not meet the predetermined condition, the information processing apparatus 100 may determine the timing when the user U11 has accessed the predetermined online mall that provides the purchased footwear as the timing to propose the evaluation. The timing of the remeasurement and the timing of the access to the predetermined online mall are examples, and thus the information processing apparatus 100 may determine any timing as the timing to propose the evaluation without limitation to these examples. For example, when the information processing apparatus 100 has delivery status, the information processing apparatus 100 may determine a timing of completion of delivery (arrival of the purchased footwear) as the timing to propose the evaluation.

The following describes the case that the information processing apparatus 100 determines the proposal content to propose the evaluation. As described above, when the user U11 is the child, since the development of the child's feet has not stopped yet, it is presumed that the proper evaluation may not be obtained if the evaluation is made at the same timing as the timing for the adult. In addition to the timing to propose the evaluation, it is also presumed that the proper evaluation may not be obtained if the evaluation of the footwear in child size is proposed with the same proposal content as the content for the adult. Accordingly, for example, even if it is appropriate in the adult case to ask, “How was the size of the footwear?”, it may be better in the child case to ask with an explicit evaluation timing such as, “How was the size of the footwear at the time of purchase?”

For example, when the attribute of the user U11 meets the predetermined condition (e.g., when the age of the user U11 is equal to or higher than the predetermined threshold), the information processing apparatus 100 determines to propose the evaluation by asking without the explicit evaluation timing. On the contrary, for example, when the attribute of the user U11 does not meet the predetermined condition (e.g., when the age of the user U11 is lower than the predetermined threshold), the information processing apparatus 100 determines to propose the evaluation by asking with the explicit evaluation timing. How to ask without the explicit evaluation timing and how to ask with the explicit evaluation timing are defined beforehand.

Meanwhile, when the related user of the user U11 has purchased the footwear for the user U11, it is presumed that an evaluating person may be the related user rather than the user U11. For example, this applies to a case that the related user performs the evaluation for the user U11. Accordingly, for example, even if it is appropriate in the adult case to ask without an explicit statement of the evaluating person, it may be better in the child case to ask with the explicit statement that the evaluating person is the child such as, “What did your child think of the size of the footwear?” Furthermore, it may be better to ask with the explicit evaluation timing and the explicit statement that the evaluating person is the child such as, “What did your child think of the size of the footwear that you purchased for your child at the time of purchase?” When the attribute of the user U11 does not meet the predetermined condition, for example, the information processing apparatus 100 determines to propose the evaluation by asking with the explicit evaluating person. How to ask without the explicit evaluating person and how to ask with the explicit evaluating person are defined beforehand. Meanwhile, when the evaluating person is the related user, it may be better to ask, “How was the toe room?” (an objective evaluation [enough, a little, or none] by the related user), instead of asking a subjective evaluation (very good, not bad, or bad) by the user U11. This is because when the user U11 is a child who is too young, the user U11 may parrot words (if asked, “Very good?”, the user answers, “Very good.”, and if asked, “Not bad?”, the user answers “Not bad.”), and thus it is presumed that the proper evaluation may not be obtained. When the attribute of the user U11 does not meet the predetermined condition, for example, the information processing apparatus 100 presumes that the evaluating person is the related user, and determines to propose the evaluation by asking according to the attribute of the user U11.

The following describes the case that the information processing apparatus 100 determines the evaluation weighting according to the attribute. When the user U11 is the child, and the evaluation is made by the child who is too young, it is presumed that the proper evaluation may not be obtained because the child can not properly judge the size. Thus, for example, even if the evaluation weighting according to the age is not appropriate in the adult case, the evaluation weighting according to the age may be appropriate in the child case.

When the attribute of the user U11 does not meet the predetermined condition, for example, the information processing apparatus 100 determines the evaluation weighting such that an evaluation weight decreases as the attribute of the user U11 deviates more from an attribute of the predetermined condition. For example, when the age of the predetermined condition is 20 years, the information processing apparatus 100 determines the evaluation weighting such that the evaluation weight is smaller when the age of the user U11 is 5 years than when it is 15 years. Alternatively, the information processing apparatus 100 may determine the evaluation weighting based on an attribute based on the age, such as an elementary school student or a junior high school student, instead of the age. For example, when the attribute based on the age of a predetermined condition is an adult (20 years or older), the information processing apparatus 100 may determine the evaluation weighting such that the evaluation weight is smaller when the attribute based on the age of the user U11 is the elementary school student than when it is the junior high school student.

So far, determination of the information for evaluating the size of the purchased footwear has been described.

The information processing apparatus 100 provides information for proposing the evaluation based on the information for evaluating the size of the purchased footwear (step S103). For example, the information processing apparatus 100 provides the information for proposing the evaluation at the timing determined to propose the evaluation. For example, the information processing apparatus 100 may perform processing for notifying the information for proposing the evaluation (e.g., by a push notification) on a screen of the terminal apparatus 10 at the timing of the remeasurement, access to the predetermined online mall, or the like. Furthermore, for example, the information processing apparatus 100 provides the information for proposing the evaluation with the content determined as the proposal content for proposing the evaluation. For example, the information processing apparatus 100 may perform processing for notifying the information with the content determined as the proposal content for proposing the evaluation on the screen of the terminal apparatus 10. Then, the information processing apparatus 100 acquires evaluation information of the evaluation of the size of the purchased footwear received from the user (step S104).

Next, validity of the evaluation based on the information for evaluating the size of the purchased footwear is described. For example, when the user makes the evaluation after a long interval from the purchase, it is presumed that neither an adult nor a child may be able to properly judge the size at the time of purchase. Accordingly, it is presumed that the proper evaluation may not be obtained when a certain time period has passed since the purchase. When the attribute of the user U11 meets the predetermined condition (e.g., when the age of the user U11 is equal to or higher than the predetermined threshold), the information processing apparatus 100 decides that an evaluation result evaluated within a predetermined time period (hereinafter referred to as a “first valid period” as appropriate) after the purchase of the footwear is valid. For example, the valid period is two years after the purchase of the footwear. Furthermore, when the attribute of the user U11 does not meet the predetermined condition (e.g., when the age of the user U11 is lower than the predetermined threshold), the information processing apparatus 100 decides that an evaluation result evaluated within a time period (hereinafter referred to as a “second valid period” as appropriate) shorter than the first valid period after the purchase of the footwear is valid. In the latter case, for example, the information processing apparatus 100 decides that an evaluation result evaluated within a time period (hereinafter referred to as a “first period” as appropriate) estimated to be taken until the foot size of the user meets a predetermined condition is valid. The first period is described later in detail. As described above, the information processing apparatus 100 decides the validity of the evaluation, and determines that the evaluation result based on the evaluation decided to be valid is the evaluation result based on the information for evaluating the size of the purchased footwear (step S105).

Furthermore, assume that the user purchases the footwear that has been proposed based on a measurement result after a certain time period from the measurement of the foot size. When the user is the child, it is presumed that the proper evaluation may not be obtained after the certain time period from the measurement of the foot size since the foot development has not stopped yet (the foot development continues even between the measurement and the purchase). When the attribute of the user U11 does not meet the predetermined condition (e.g., when the age of the user U11 is lower than the predetermined threshold), the information processing apparatus 100 decides that an evaluation result evaluated within a time period (hereinafter referred to as a “third valid period” as appropriate) shorter than the first valid period after the measurement of the foot size is valid. For example, the information processing apparatus 100 decides that the evaluation result evaluated within the time period (hereinafter referred to as the “first period” as appropriate) estimated to be taken until the foot size of the user meets the predetermined condition is valid.

The information processing apparatus 100 accesses the management server 200 (step S106). For example, the information processing apparatus 100 accesses the management server 200 managing the predetermined online mall that provides the purchased footwear.

The information processing apparatus 100 provides information for proposing footwear in a size suitable for the foot development based on the evaluation result based on the information for evaluating the size of the purchased footwear (step S107). For example, when the evaluation result is affirmative such as “good”, the information processing apparatus 100 learns the result as positive data to provide the information for proposing the footwear in the size suitable for the foot development. Furthermore, for example, when the evaluation result is negative such as “bad”, the information processing apparatus 100 learns the result as negative data to provide the information for proposing the footwear in the size suitable for the foot development. The information processing apparatus 100 may provide the information for proposing the footwear in the size suitable for the foot development of the user U11 based on the evaluation result by the user U11, or may provide the information for proposing the footwear in the size suitable for the foot development of the user U11 based on the evaluation result by another user different from the user U11.

As described above, there is the case that the user U11 is a child and the user who purchases the footwear using the terminal apparatus 10 is a parent of the user U11, for example. In such a case, in addition to the case of providing the information for the user U11, the information processing apparatus 100 may provide the information for the related user of the user U11 in the step S107. Accordingly, the user U11 can be read as the related user. Generally speaking, since the foot development of children is fast, parents may fail to notice the development and leave the footwear size unsuitable. The information processing apparatus 100 can promote usability improvement such as preventing the footwear size from remaining unsuitable.

The foregoing embodiment has been described with an example where the information processing apparatus 100 determines the evaluation weighting according to the attribute as the information for evaluating the size of the purchased footwear. However, this example does not constitute any limitation. For example, when the evaluation is made after a long interval from the purchase, it is presumed that the user may not be able to properly judge the size at the time of purchase, and thus the proper evaluation may not be obtained. In addition to the case where the evaluation weight is determined according to the attribute, the information processing apparatus 100 may determine the evaluation weight according to a time period taken before the evaluation is made. In particular, the information processing apparatus 100 may determine the evaluation weighting such that the evaluation weight decreases as the time period taken before the evaluation is made extends longer after the information for proposing the evaluation is provided. For example, the information processing apparatus 100 may determine the evaluation weighting such that the evaluation weight is smaller when the time period taken before the evaluation is made is one month than when it is one day. Furthermore, the information processing apparatus 100 may determine the evaluation weighting based on the evaluation weighting according to the attribute and the evaluation weighting based on the time period taken before the evaluation is made by multiplying both the evaluation weighting, for example.

As described above, the footwear in the size suitable for the foot development may be the footwear proposed by the information processing apparatus 100 in the step S101. The following describes an example of processing for proposing the footwear in the size suitable for the foot development. The following embodiment is described with an example where the information processing apparatus 100 proposes the footwear based on the first period. However, this example does not constitute any limitation.

The information processing apparatus 100 acquires measurement information of measuring the foot size of the user U11. The following embodiment is described on the assumption that the information processing apparatus acquires the measurement information measured at an arbitrary timing, for the convenience of explanation. However, the information processing apparatus 100 may acquire measurement history information including a plurality of pieces of measurement information measured at a plurality of timings to acquire the measurement information measured at the arbitrary timing from the measurement history information. The following embodiment is described on the assumption that the information processing apparatus 100 acquires the measurement information measured at a certain timing (hereinafter referred to as a “first timing” as appropriate). The information processing apparatus 100 may acquire the measurement information of measuring the foot size of the user U11 by any method. In other words, the foot size of the user U11 may be measured by any method in the following embodiment. For example, the foot size of the user U11 may be measured via a measurement means capable of measuring a three-dimensional size of the foot based on dots (markers) on a mat where the user's foot is placed so as to image (photograph) a circumference of the foot by the terminal apparatus 10. Alternatively, for example, when the user U11 is a child, imaging may be performed with the terminal apparatus 10 used by a parent of the user U11. In such a case, the information processing apparatus 100 may acquire the measurement information of the user U11 from the patent of the user U11.

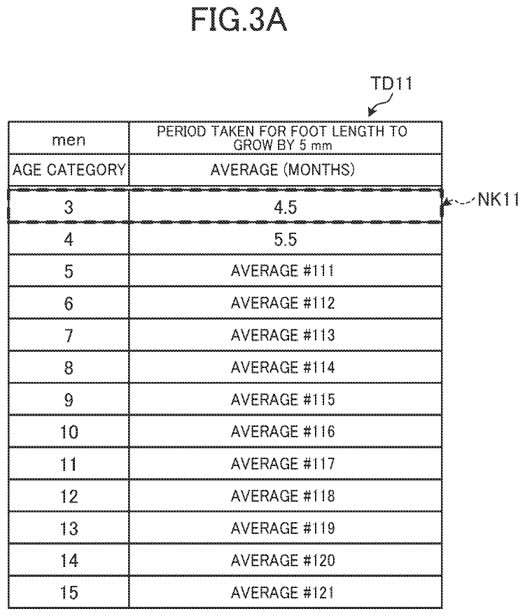

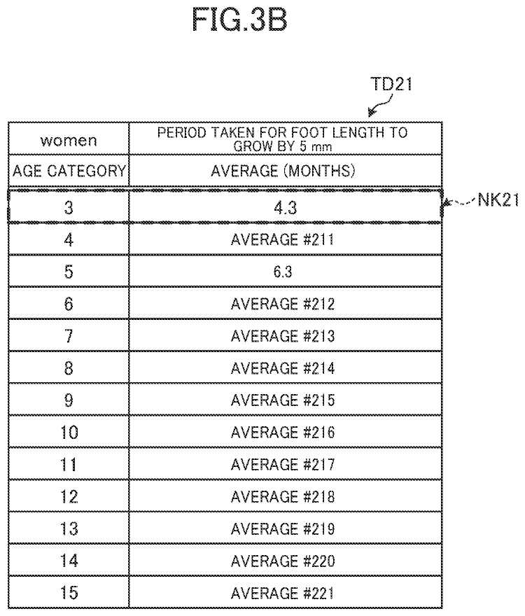

The information processing apparatus 100 determines the foot development pattern based on the attribute of the user U11 at the first timing. The attribute of the user U11 at the first timing may be the one identified based on the user information of the user U11 or the one estimated based on the measurement information at the first timing. In the latter case, for example, the attribute may be the one estimated based on a comparison between the measurement information at the first timing and statistical data TD11 or TD21 described later. Here, the foot development pattern according to the age and sex is described with reference to FIG. 3A and FIG. 3B. In particular, FIG. 3A is a table showing a foot development pattern of males according to the age, and FIG. 3B is a table showing a foot development pattern of females according to the age.

FIG. 3A shows an example of the statistical data TD11 of a time period taken for the foot length (length from a tip of a longest toe to a heel) of males to grow by 5 mm according to the age. For example, FIG. 3A shows an example where the age identified by an age category NK11 is three years, and an average time period taken for the foot length to grow by 5 mm is 4.5 months. Although FIG. 3A includes examples where conceptual information such as “average #111” or “average #112” is stored in the average of the time period taken for the foot length to grow by 5 mm, numerical values such as “4.5” for the age category of three years are stored in practice. A maximum time period or a minimum time period taken for the foot length to grow by 5 mm may be included.

FIG. 3B shows an example of the statistical data TD21 of a time period taken for the foot length of females to grow by 5 mm according to the age. For example, FIG. 3B shows an example where the age identified by an age category NK21 is three years, and an average time period taken for the foot length to grow by 5 mm is 4.3 months. Although FIG. 3A includes examples where the conceptual information such as “average #211” or “average #212” is stored in the average of the time period taken for the foot length to grow by 5 mm, the numerical values such as “4.3” for the age category of three years are stored in practice. A maximum time period or a minimum time period taken for the foot length to grow by 5 mm may be included.

The information processing apparatus 100 compares the attribute of the user U11 at the first timing with predetermined statistical data to determine the foot development pattern to apply to the user U11 at the first timing. For example, when the attribute of the user U11 at the first timing is “age: 3 years, sex: male”, the information processing apparatus 100 selects the statistical data TD11 from the statistical data TD11 and TD21, and selects the age category NK11 from the statistical data TD11. Then, the information processing apparatus 100 determines the information that “the average of the time period taken for the foot length to grow by 5 mm is 4.5 months” as the foot development pattern to apply to the user U11 at the first timing.

The information processing apparatus 100 can estimate that the average of the time period taken for the foot length of the user U11 at the first timing to grow by 5 mm is 4.5 months based on the determined foot development pattern. The following embodiment is described with an example where the average of the time period taken for the foot length to grow by 5 mm is used, for the convenience of explanation.

The information processing apparatus 100 estimates the first period taken until the foot size of the user U11 meets the predetermined condition. In particular, the information processing apparatus 100 estimates the first period based on the measurement information at the first timing and the foot development pattern to be applied to the user U11 at the first timing. For example, assume that the measurement information at the first timing is a foot length of 14 cm, and the foot development pattern is “the average of the time period taken to grow by 5 mm: 4.5 months”. Furthermore, for example, assume that the predetermined condition related to the estimation of the first period is a foot length of 15 cm. In this case, since a difference between the measurement information at the first timing and the predetermined condition related to the estimation of the first period is 1 cm, which is twice the length of 5 mm, the information processing apparatus 100 estimates the first period to be nine months that are twice the length of the time period taken to grow by 5 mm. Meanwhile, when the attribute of the user U11 after 4.5 months from the first timing is “age: 4 years, sex: male”, the information processing apparatus 100 may estimate the time period taken to grow by 1 cm to be ten months (the average period of 4.5 months for three years+the average period of 5.5 months for four years).

The information processing apparatus 100 accesses the management server 200. For example, the information processing apparatus 100 accesses the management server 200 managing the predetermined online mall that provides the footwear proposed or purchased at the first timing.

The information processing apparatus 100 provides the information for proposing the footwear (or proposing purchase of the footwear) corresponding to the foot size of the user U11 after a lapse of the first period based on an estimation result. As described above, the information processing apparatus 100 provides the information for proposing the footwear in the size suitable for the foot development of the user U11. For example, the information processing apparatus 100 provides the information at the timing immediately before nine months have passed, the timing before and after nine months have passed, or the timing after nine months have passed based on the estimation result estimating the first period to be nine months. At this time, in addition to the case of providing the information for the user U11, the information processing apparatus 100 may provide the information for the related user of the user U11. Furthermore, after proving the information, the information processing apparatus 100 may provide the information (e.g., a questionnaire) for confirming whether the proposal has been appropriate. Then, the information processing apparatus 100 may change the foot development pattern to apply to the user U11 thereafter according to a response result of whether the proposal has been appropriate. Furthermore, the information processing apparatus 100 may modify the statistical data (e.g., the average time period for each age) according to the response result of whether the proposal has been appropriate. Meanwhile, the proposal may be made based on any reason, and, for example, the proposal may be made based on the reason that the footwear size proposed at the first timing is not suitable. Furthermore, the proposal is not limited to the one stating a vague reason such as that the size is not suitable or that it is better to purchase new footwear, but may be the one stating a concreate reason with an explicit indication of a specific part of the foot such as that a heel area is tight, or that the foot length has grown.

The following describes the footwear size proposed by the information processing apparatus 100. The foot size of the user U11 after the lapse of the first period is presumed to be larger than the size at the first timing. Thus, the information processing apparatus 100 provides the information for proposing the footwear in the size larger than the footwear corresponding to the foot size based on the measurement information at the first timing at the timing immediately before the first period has passed, the timing before and after the first period has passed, or the timing after the first period has passed. For example, when the measurement information at the first timing is a foot length of 14 cm, the information processing apparatus 100 provides the information for proposing the footwear corresponding to the foot size larger than the foot length of 14 cm. For example, the information processing apparatus 100 provides the information for proposing the footwear in one size larger than the size corresponding to the foot length of 14 cm based on footwear size standards.

The information processing apparatus 100 may provide the information for proposing the same footwear in a different size or the footwear of the same brand as the footwear proposed or purchased at the first timing based on the measurement information at the first timing. For example, when the user U11 has purchased “footwear AA1 of a brand A1: size 14 cm”, the information processing apparatus 100 may provide the information for proposing “footwear AA1: size 15 cm” that is the same footwear as the footwear AA1 in a different size, or “footwear AA2 of the brand A1: size 15 cm” that is the footwear of the same brand as the brand of the footwear AA1 in a different size.

The foregoing embodiment has been described with the foot length as an example of an index for indicating the foot size for the convenience of explanation. However, this example does not constitute any limitation. For example, the information processing apparatus 100 may estimate the first period based on measurement information of foot circumference or foot width of the user U11. The foot circumference and foot width have various definitions. For example, the foot circumference is defined as a length around an area from a base of a first toe (big toe) to a base of a fifth toe (little toe) or a length around boll joints at the bases of the first toe and fifth toe, and the foot width is defined as a length of a width of a widest portion. However, these examples do not constitute any limitation. Here, since development speed is different for each foot part, the first period is different for each foot part. For example, the foot circumference keeps growing after the foot length has stopped growing. Since the development speed is different for each foot part, the information processing apparatus 100 may estimate the first period taken until predetermined conditions respectively corresponding to the foot circumference and the foot width are met based on development patterns respectively corresponding to the foot circumference and the foot width.

The foregoing embodiment has been described with an example where the foot development pattern is determined based on the age and sex for the convenience of explanation. However, this example does not constitute any limitation. For example, the foot development pattern of a taller user is presumed to be faster than that of a shorter user. Furthermore, the growth of a particular foot part of a heavier user is presumed to be larger than that of a lighter user. Accordingly, the foot circumference and foot width of the heavier user are presumed to be larger (the foot development pattern is faster) than the foot circumference and foot width of the lighter user. Furthermore, the foot development pattern is presumed to be different for each race (or nationality). Furthermore, the development pattern of each foot part is also presumed to be different. The information processing apparatus 100 may determine the foot development pattern with the height, weight, race, or the like as the attribute. Furthermore, it is presumed that accuracy of determination of the foot development pattern is higher when measurement of the foot size is performed several times than once. The information processing apparatus 100 may determine the foot development pattern with a number of times of measurement of the foot size as the attribute. For example, the information processing apparatus 100 may decide whether the number of times of measurement is equal to or higher than a predetermined threshold, and when deciding that the number of times of measurement is equal to or higher than the predetermined threshold, the information processing apparatus 100 may determine the foot development pattern.

### (Variation of Information Processing)

The following describes a variation of processing for proposing the footwear in the size suitable for foot development.

### (Consideration of Purchase Tendency)

The following describes a case where the information processing apparatus 100 makes a proposal in consideration of a purchase tendency of the user U11 in the foregoing embodiment. For example, even if the footwear in size 14 cm is proposed to the user U11 at the first timing based on the measurement information at the first timing, the footwear purchased by the user U11 may be the footwear in size 14.5 cm. When such a case happens once or several times, the information processing apparatus 100 may presume that the user U11 has a tendency to purchase the footwear in a size larger than the size suitable for the user. Then, based on the purchase tendency of the user U11 to purchase the larger size, the information processing apparatus 100 may estimate the first period to be a time period shorter by a length of time considering the purchase tendency as compared with the case not considering the purchase tendency, for example. For example, when the size of the proposed footwear is 14 cm and the size of the purchased footwear is 14.5 cm, the difference is 5 mm. Accordingly, the information processing apparatus 100 may estimate the first period to be a time period shorter by a length of time corresponding to 5 mm as compared with the case not considering the purchase tendency.

The information processing apparatus 100 may provide the information for proposing the footwear in a size larger by an amount considering the purchase tendency as compared with the case not considering the purchase tendency, for example. For example, assume that the size of the proposed footwear at the first timing is 14 cm and the size of the purchased footwear is 14.5 cm. The information processing apparatus 100 may provide the information for proposing the footwear in size 15.5 cm when the footwear size to be proposed as the footwear size corresponding to the foot size of the user U11 after the lapse of the first period is 15 cm without consideration of the purchase tendency. In this case, the information processing apparatus 100 may provide the information for proposing the footwear in size 15.5 cm even if the information processing apparatus 100 has estimated the first period by setting the predetermined condition to 15 cm.

### (Consideration of Stock Quantity)

The following describes a case where the information processing apparatus 100 makes a proposal in consideration of stock quantity of the footwear in the foregoing embodiment. For example, when the user U11 has purchased “footwear AA1 of a brand A1: size 14 cm”, the information processing apparatus 100 provides the information, for example, for proposing “footwear AA1: size 15 cm” that is the same footwear as the footwear AA1 in a different size if the stock quantity of the footwear is not considered. However, the stock quantity of the “footwear AA1: size 15 cm” may be extremely small (or none). For example, when, of all the same footwear as the footwear AA1 in different sizes, only the stock quantity of the footwear AA1 in size 15 cm is extremely small as compared with the stock quantities of the footwear AA1 in other sizes, the information processing apparatus 100 may provide the information for proposing the footwear in size 15.5 cm that is close to the size 15 cm, or the information for proposing “footwear AA2 of the brand A1: size 15 cm” that is the footwear of the same brand as the brand of the footwear AA1.

### (Change in Proposed Brand in Consideration of Attribute)

The following describes a case where the information processing apparatus 100 changes the brand of the footwear to propose in consideration of the attribute of the user U11 in the foregoing embodiment. For example, when the user U11 has purchased “footwear AA1 of a brand A1: size 14 cm”, the information processing apparatus 100 provides the information, for example, for proposing “footwear AA2 of the brand A1: size 15 cm” that is the footwear of the same brand as the brand of the footwear AA1 if the attribute of the user U11 is not considered. However, a brand A2 may be more suitable for the attribute of the user U11 (the attribute of the user U11 at the first timing or the attribute of the user U11 after the lapse of the first period) than the brand A1. For example, this applies to a case that the brand A2 sets users having the same attribute as the attribute of the user U11 as target users more than the brand A1. In this case, the information processing apparatus 100 may select the footwear corresponding to the foot size of the user U11 after the lapse of the first period from the footwear of the brand A2 that is more suitable for the attribute of the user U11 than the brand A1, and provide the information for proposing the selected footwear. For example, the information processing apparatus 100 may provide the information for proposing “footwear BB1 of the brand A2: size 15 cm”. Furthermore, when a plurality of brands are more suitable for the attribute of the user U11 than the brand A1, the information processing apparatus 100 may provide the information for proposing the footwear similar to the brand A1 in design or concept.

### (Provision of Incentive)

The following describes a case where the information for proposing the footwear includes information on an incentive to be provided upon purchase of the proposed footwear in the foregoing embodiment. The information processing apparatus 100 may provide the information on the incentive to be provided for the user who has purchased the proposed footwear along with the information for proposing the footwear. For example, as the information on the incentive, the information processing apparatus 100 may provide information on beneficial treatment for the user who has purchased the proposed footwear within a predetermined time period after the proposal. The incentive may be anything. For example, the incentive may be a benefit that provides free shipping for the purchase of the footwear, or a benefit that provides points usable for the purchase at the predetermined online mall. As an example of the latter case, the incentive may be a benefit that provides points equivalent to 10% of the price of the footwear upon purchase of the footwear. Furthermore, as another example of the latter case, the incentive may be a benefit that provides points equivalent to 20% of the price of the footwear upon purchase of the same footwear or the footwear of the same brand as the footwear purchased at the first timing. Furthermore, as another example of the latter case, the incentive may be a benefit that provides more points as the user makes a purchase earlier.

### (Proposal for Replacement Purchase)

The following describes a case where the information processing apparatus 100 makes a proposal for replacement purchase, which includes a proposal for releasing the footwear along with or instead of a proposal for purchasing the footwear, in the foregoing embodiment. The information processing apparatus 100 may provide the information for proposing release of the footwear purchased at the first timing, which is a basis for proposing the purchase of the footwear. The information processing apparatus 100 may provide the information on the incentive to be provided for the user who has made the replacement purchased in response to the proposal. For example, as the information on the incentive, the information processing apparatus 100 may provide the information on beneficial treatment for the user who has made the proposed replacement purchase and has released the target footwear to be released within a predetermined time period after the proposal for the replacement purchase. For example, the incentive may be a benefit that provides free shipping for the replacement purchase (e.g., shipping cost for the purchased footwear and shipping cost for the footwear to be released). Furthermore, for example, the incentive may be a benefit that provides points equivalent to 10% of the price of the purchased footwear. Furthermore, for example, the incentive may be a benefit that provides points equivalent to 20% of the price of the footwear upon purchase of the same footwear or the footwear of the same brand as the footwear purchased at the first timing. Furthermore, for example, the incentive may be a benefit that provides more points as the user makes the replacement purchases earlier. Furthermore, for example, the incentive may be a benefit that sets a buying price higher than a usual price for the target footwear to be released. Furthermore, for example, the incentive may be a benefit that sets the buying price higher than the usual price for the target footwear to be released upon purchase of the same footwear or the footwear of the same brand as the footwear purchased at the first timing. Furthermore, for example, the incentive may be a benefit that sets the buying price higher than the usual price for the target footwear to be released as the user makes the replacement purchase earlier. Meanwhile, the footwear that is to be the target of the release proposal may be used longer than the first period by repair or maintenance. For example, when the footwear is made of leather, the footwear may fit the feet of the user again by reinforcing loose part of the leather to fix the looseness of the leather. When the footwear that is to be the target of the release proposal can be reinforced by repair or maintenance, the information processing apparatus 100 may estimate the first period to be a time period longer than the first period by a length of time considering the reinforcement. In this case, the information processing apparatus 100 may make a proposal for the repair or maintenance instead of the proposal for the replacement purchase.

### (Proposal for Remeasurement 1)

The following describes a case where the information processing apparatus 100 makes a proposal for remeasurement of the foot size in the foregoing embodiment. Since the development speed of each individual user is different, the estimation of the first period made by the information processing apparatus 100 may not be proper. Thus, it is presumed that remeasurement of the foot size enables an accurate proposal of the footwear suitable for the foot development of the user. The information processing apparatus 100 may provide the information for proposing the remeasurement of the foot size for the user U11 at the timing immediately before the first period has passed, the timing before and after the first period has passed, or the timing after the first period has passed. The information processing apparatus 100 may provide the information on the incentive to be provided for the user who has taken the remeasurement. For example, as the information on the incentive, the information processing apparatus 100 may provide the information on beneficial treatment for the user who has taken the remeasurement within a predetermined time period after the proposal for the remeasurement. For example, the incentive may be a benefit that provides points usable for the purchase at the predetermined online mall upon remeasurement. Furthermore, for example, the incentive may be a benefit that provides more points as the user takes the remeasurement earlier.

### (Proposal for Remeasurement 2)

The following describes a case where the information processing apparatus 100 provides the information for proposing the footwear suitable for the feet of the user 11 at a second timing based on re-measured measurement information at the second timing, and estimates a second period taken until the foot size meets a predetermined condition in the foregoing embodiment. The information processing apparatus 100 may acquire the measurement information of the foot size of the user U11 at the second timing, which has been measured within a predetermined time period after the proposal for the remeasurement. Then, the information processing apparatus 100 may estimate the second period based on the measurement information at the second timing and a foot development pattern based on an attribute of the user U11 at the second timing. Then, the information processing apparatus 100 may provide the information for proposing footwear in a size larger than the size of the footwear corresponding to the foot size based on the measurement information at the second timing.

The information processing apparatus 100 may provide the information for proposing the same footwear in a different size or the footwear of the same brand as the footwear proposed or purchased at the second timing based on the measurement information at the second timing. For example, when the user U11 has purchased “footwear AA1 of a brand A1: size 15 cm” proposed at the second timing based on the measurement information at the second timing, the information processing apparatus 100 may provide the information for proposing “footwear AA1: size 16 cm” that is the same footwear as the footwear AA1 in a different size, or “footwear AA2 of the brand A1: size 16 cm” that is the footwear of the same brand as the brand of the footwear AA1 in a different size at a timing immediately before the second period has passed, a timing before and after the second period has passed, or a timing after the second period has passed.

### (Termination of Proposal)

The following describes a case where the information processing apparatus 100 terminates the proposal of the footwear based on the measurement information at the first timing in the foregoing embodiment. The information processing apparatus 100 may perform processing for not providing the information for proposing the footwear based on the measurement information of the foot size of the user U11 at the first timing at the timing immediately before the first period has passed, the timing before and after the first period has passed, or the timing after the first period has passed. For example, the information processing apparatus 100 may decide whether the first period has passed, and when deciding that the first period has passed, the information processing apparatus 100 may perform processing for terminating the proposal of the footwear based on the measurement information at the first timing. The information processing apparatus 100 may decide whether to terminate the proposal depending on the attribute of the user U11. For example, when the age of the user U11 is equal to or higher than the predetermined threshold (i.e., when the user U11 is an adult), the information processing apparatus 100 may decide not to perform the processing for terminating the proposal. This is because the foot size of the user U11 is presumed not to change with age. In this case, the information processing apparatus 100 may make a proposal of the same footwear as the footwear proposed at the first timing even after the first period has passed. On the contrary, when the age of the user U11 is lower than the predetermined threshold (i.e., when the user U11 is a child), the information processing apparatus 100 may decide to perform the processing for terminating the proposal. In this case, when the footwear proposed at the first timing is “footwear AA1: size 14 cm”, the information processing apparatus 100 may terminate the proposal of the “footwear AA1: size 14 cm” after the lapse of the first period, and perform processing for proposing “footwear AA1: size 15 cm” that is larger in size than the “footwear AA1: size 14 cm”.

### (Notification of Inappropriateness)

The following describes a case where the information processing apparatus 100 notifies that the footwear specified for purchase is inappropriate in the foregoing embodiment. The information processing apparatus 100 may provide the information for notifying that the size is not suitable when the same size as the footwear size based on the measurement information of the foot size of the user U11 at the first timing is specified at the timing immediately before the first period has passed, the timing before and after the first period has passed, or the timing after the first period has passed. For example, assume that the footwear proposed based on the measurement information of the foot size of the user U11 at the first timing was “footwear AA1: size 14 cm”. Although the user U11 did not purchase it at the first timing when it was proposed, the user may try to purchase it after the first period has passed. The information processing apparatus 100 may provide the information for notifying that the size is not suitable when the user specifies the footwear proposed at the first timing for purchase after the first period has passed, and the size of the specified footwear is the same as the size proposed at the first timing. The information processing apparatus 100 may decide whether to perform the processing for notifying inappropriateness depending on the attribute of the user U11. For example, when the age of the user U11 is equal to or higher than the predetermined threshold, the information processing apparatus 100 may decide not to perform the processing for notifying the inappropriateness. On the contrary, when the age of the user U11 is lower than the predetermined threshold, the information processing apparatus 100 may decide to perform the processing for notifying the inappropriateness.

### (Proposal Based on Individual Development Speed)

The following describes a case where the information processing apparatus 100 makes a proposal based on the development speed of an individual user in the foregoing embodiment. Since the development speed of each individual user is different, the development speed of the feet is also different, of course. Furthermore, when the development speed of a user is fast, the development speed of the feet of the user is presumed to be fast as well. The information processing apparatus 100 may apply weighting to the foot development pattern to be applied to the user according to the development speed of the individual user. Then, the information processing apparatus 100 may estimate the first period based on the foot development pattern applied with the weighting. Furthermore, the information processing apparatus 100 may determine which to use among an average value, a maximum value, and a minimum value as a time period taken for the foot length to grow by 5 mm according to the development speed of the individual user.

### (Proposal Based on Footwear Type)

The following describes a case where the information processing apparatus 100 makes a proposal in consideration of a type of footwear in the foregoing embodiment. For example, increments of available sizes may differ between cases where the footwear is sneakers or sandals. For example, in the case of sneakers, sizes are available with 5 mm increments such as 14 cm, 14.5 cm, 15 cm, 15.5 cm, and 16 cm. However, in the case of sandals, sizes are available with 1 cm increments such as 14 cm, 15 cm, and 16 cm. In the embodiment described above, the information processing apparatus 100 performs the processing for providing the information for proposing the footwear in a size larger than the footwear size corresponding to the foot size based on the measurement information at the first timing. At this time, the information processing apparatus 100 may identify the type of the footwear, estimate the increments of the available sizes based on the identified type of the footwear, and provide the information for proposing the footwear, for example, in one size larger than the footwear size corresponding to the foot size based on the measurement information at the first timing. At this time, the information processing apparatus 100 may identify the type of the footwear based on a time when the footwear was purchased at the first timing, or a time when the footwear in the size larger than the footwear size corresponding to the foot size based on the measurement information at the first timing is proposed (e.g., after the lapse of the first period). For example, it is presumed that the time when the footwear is likely to be purchased is different depending on the type of the footwear. For example, it is presumed that the sandals are likely to be purchased only in summer as compared with the sneakers. The information processing apparatus 100 may identify the type of the footwear based on the time when the footwear was purchased at the first timing, or the time when the footwear in the size larger than the footwear size corresponding to the foot size based on the measurement information at the first timing is proposed (e.g., after the lapse of the first period), estimate the increments of the available sizes based on the identified type of the footwear, and perform the proposal processing.

### 3. Configuration of Terminal Apparatus

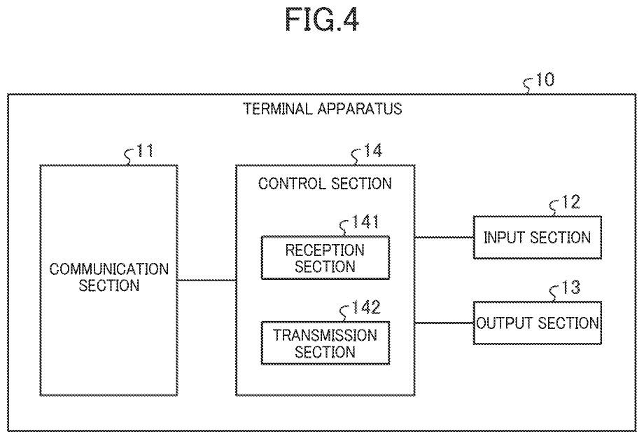

Next, a configuration of the terminal apparatus 10 according to the embodiment is described with reference to FIG. 4. FIG. 4 is a diagram illustrating a configuration example of the terminal apparatus 10 according to the embodiment. As shown in FIG. 4, the terminal apparatus 10 includes a communication section 11, an input section 12, an output section 13, and a control section 14.

### (Communication Section 11)

The communication section 11 is implemented by a network interface card (NIC) or the like, for example. The communication section 11 is connected to a predetermined network N by wired or wireless to transmit and receive information to/from the information processing apparatus 100 or the like via the predetermined network N.

### (Input Section 12)

The input section 12 receives various operations from the user. In the example shown in FIG. 2, the input section receives the various operations from the user U11. For example, the input section 12 may receive the various operations from the user by a touch-panel function via a display screen. Furthermore, the input section 12 may receive the various operations from buttons disposed on the terminal apparatus 10 or a keyboard or a mouse connected to the terminal apparatus 10.

### (Output Section 13)

The output section 13 is a display screen of a tablet terminal or the like implemented by a liquid crystal display, an organic electro-luminescence (EL) display, or the like, and is a display device for displaying various information, for example. For example, the output section 13 displays information received from the information processing apparatus 100.

### (Control Section 14)

The control section 14 is, for example, a controller, and is implemented by a central processing unit (CPU), a micro processing unit (MPU), or the like that executes various programs stored in a storage device embedded in the terminal apparatus 10 using a random access memory (RAM) as a work area. For example, the various programs include application programs installed on the terminal apparatus 10. For example, the various programs include an application program to display the information received from the information processing apparatus 100. Furthermore, the control section 14 is implemented by an integrated circuit such as an application specific integrated circuit (ASIC), or a field programable gate array (FPGA), for example.

As shown in FIG. 4, the control section 14 includes a reception section 141 and a transmission section 142, and implements or executes functions of information processing described below.

### (Reception Section 141)

The reception section 141 receives various information. The reception section 141 receives the various information from external information processing apparatuses. The reception section 141 receives the various information from other information processing apparatuses such as the information processing apparatus 100. For example, the reception section 141 receives information for proposing evaluation. Furthermore, for example, the reception section 141 receives information for proposing footwear in a size suitable for foot development of the user. Furthermore, for example, the reception section 141 receives information on an incentive to receive beneficial treatment, information on a proposal for replacement purchase, information on a proposal for remeasurement, and information on an inappropriate size.

### (Transmission Section 142)

The transmission section 142 transmits various information to external information processing apparatuses. The transmission section 142 transmits the various information to other information processing apparatuses such as the information processing apparatus 100. For example, the transmission section 142 transmits evaluation information of an evaluation received from the user as an evaluation result. Furthermore, for example, the transmission section 142 transmits measurement information of a foot size of the user. For example, the transmission section 142 transmits measurement information measured via a measurement means capable of measuring a three-dimensional size of a foot based on dots on a mat by imaging a circumference of the foot by the terminal apparatus 10.

### 4. Configuration of Information Processing Apparatus

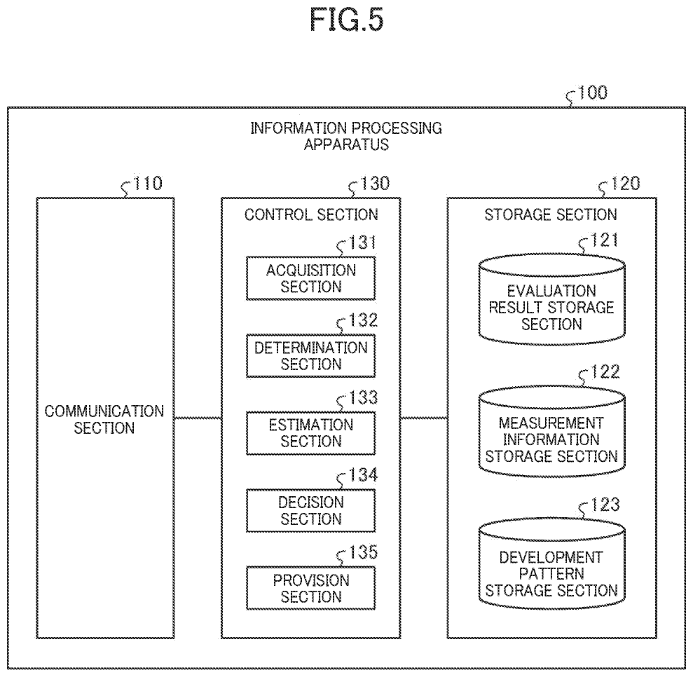

Next, a configuration of the information processing apparatus 100 according to the embodiment is described with reference to FIG. 5. FIG. 5 is a diagram illustrating a configuration example of the information processing apparatus 100 according to the embodiment. As shown in FIG. 5, the information processing apparatus 100 includes a communication section 110, a storage section 120, and a control section 130. The information processing apparatus 100 may include an input section (e.g., a keyboard or a mouse) for receiving various operations from an administrator of the information processing apparatus 100, or a display section (e.g., a liquid crystal display) for displaying various information.

### (Communication Section 110)

The communication section 110 is implemented by an NIC or the like, for example. The communication section 110 is connected to a network N by wired or wireless to transmit and receive information to/from the terminal apparatus 10 or the like via the network N.

### (Storage Section 120)

The storage section 120 is implemented, for example, by a semiconductor memory element such as a RAM or a flash memory, or a storage device such as a hard disk or an optical disk. As shown in FIG. 5, the storage section 120 includes an evaluation result storage section 121, a measurement information storage section 122, and a development pattern storage section 123.

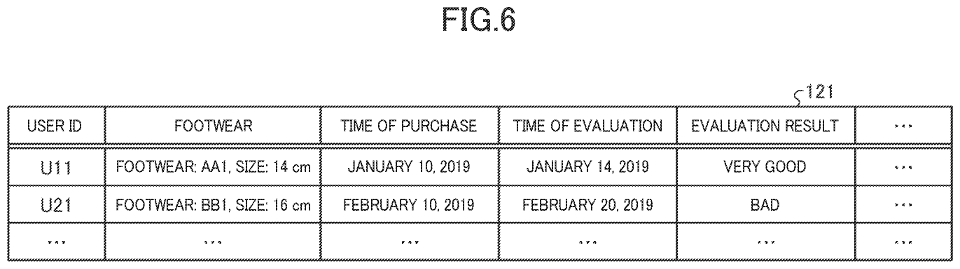

The evaluation result storage section 121 stores an evaluation result of the footwear size evaluated by the user. Here, FIG. 6 shows an example of the evaluation result storage section 121 according to the embodiment. As shown in FIG. 6, the evaluation result storage section 121 includes items such as “user ID”, “footwear”, “time of purchase”, “time of evaluation”, and “evaluation result”.

The “user ID” indicates identification information for identifying the user. The “footwear” indicates purchased footwear and a footwear size. The “time of purchase” indicates a time of purchase when the footwear is purchased. The “time of evaluation” indicates a time of evaluation when the footwear is evaluated. The “evaluation result” indicates an evaluation result by the user.

That is, FIG. 6 shows an example where the footwear purchased by the user identified by the user ID “U11” and the footwear size is “footwear: AA1, size: 14 cm”, the time of purchase is “Jan. 10, 2019”, the time of evaluation is “Jan. 14, 2019”, and the evaluation result is “very good” that is the best of four levels.

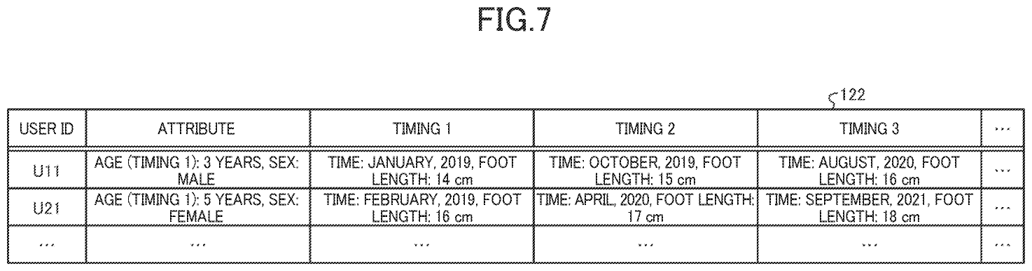

The measurement information storage section 122 stores measurement information of the foot size of the user. Here, FIG. 7 shows an example of the measurement information storage section 122 according to the embodiment. As shown in FIG. 7, the measurement information storage section 122 includes items such as “user ID”, “attribute”, “timing 1”, “timing 2”, and “timing 3”.

The “user ID” indicates identification information for identifying the user. The “attribute” indicates an attribute of the user. The “timing 1” to “timing 3” indicate the measurement information measured at arbitrary timings.

That is, FIG. 7 shows an example where the attribute of the user identified by the user ID “U11” at the timing 1 is “age (timing 1): 3 years, sex: male”, the timing 1 is “time: January, 2019, foot length: 14 cm”, the timing 2 is “time: October, 2019, foot length: 15 cm”, and the timing 3 is “time: August, 2020, foot length: 16 cm”.

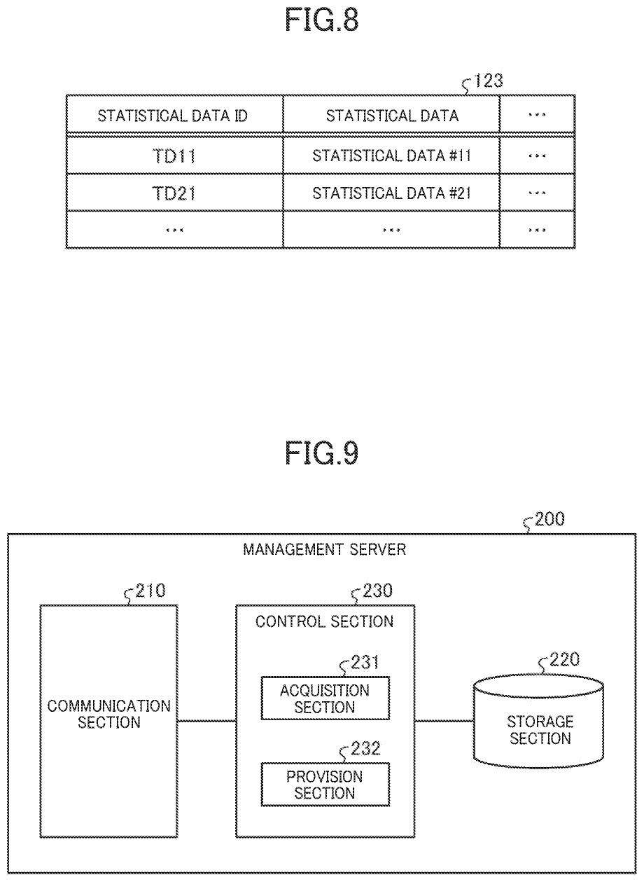

The development pattern storage section 123 stores statistical data of the foot development pattern. Here, FIG. 8 shows an example of the development pattern storage section 123 according to the embodiment. As shown in FIG. 8, the development pattern storage section 123 includes items such as “statistical data ID”, and “statistical data”.

The “statistical data ID” indicates identification information for identifying the statistical data of the foot development pattern. The “statistical data” indicates the statistical data of the foot development pattern. Although FIG. 8 shows examples where conceptual information such as “statistical data #11” or “statistical data #21” is stored in the “statistical data”, information such as “‘age: 3 years, sex: male’, ‘an average time period taken for a foot length to grow by 5 mm: 4.5 months’” is stored, for example, in practice.

That is, FIG. 8 shows an example where the statistical data identified by the statistical data ID “TD11” is “statistical data #11”.

### (Control Section 130)

The control section 130 is a controller, and is implemented, for example, by a CPU, an MPU, or the like that executes various programs stored in a storage device embedded in the information processing apparatus 100 using a RAM as a work area. Furthermore, the control section 130 is a controller, and is implemented by an integrated circuit such as an ASIC or an FPGA, for example.

As shown in FIG. 5, the control section 130 includes an acquisition section 131, a determination section 132, an estimation section 133, a decision section 134, and a provision section 135, and implements or executes functions of information processing described below. An internal configuration of the control section 130 is not limited to the configuration shown in FIG. 5, and may be any other configuration if it can perform the information processing described later.

### (Acquisition Section 131)

The acquisition section 131 acquires various information. The acquisition section 131 acquires the various information from external information processing apparatuses. The acquisition section 131 acquires the various information from other information processing apparatuses such as the terminal apparatus 10.

The acquisition section 131 acquires the various information from the storage section 120. The acquisition section 131 acquires the various information from the evaluation result storage section 121, the measurement information storage section 122, and the development pattern storage section 123. The acquisition section 131 also stores the acquired various information into the storage section 120. The acquisition section 131 stores the various information into the evaluation result storage section 121, the measurement information storage section 122, and the development pattern storage section 123.

The acquisition section 131 acquires attribute information of the user who has purchased footwear in a size suitable for the foot development.

The acquisition section 131 acquires evaluation information of an evaluation of the footwear size evaluated by the user as an evaluation result. For example, the acquisition section 131 acquires the evaluation information decided to be valid by the decision section 134, described later, as the evaluation result.

The acquisition section 131 acquires measurement information of a foot size of the user. For example, the acquisition section 131 acquires the measurement information at a first timing taken by measuring the foot size of the user. Furthermore, for example, the acquisition section 131 acquires the measurement information at a second timing taken by re-measuring the foot size of the user at the timing immediately before a first period has passed, the timing before and after the first period has passed, or the timing after the first period has passed.

The acquisition section 131 acquires statistical data of the foot development pattern. For example, the acquisition section 131 acquires the statistical data of the foot development pattern according to the attribute of the user determined based on the attribute of the user. For example, the acquisition section 131 acquires the statistical data of the foot development pattern determined by the determination section 132, described later.

### (Determination Section 132)

The determination section 132 determines information for evaluating the size of the purchased footwear based on the attribute of the user included in the attribute information acquired by the acquisition section 131. For example, the determination section 132 determines a timing to propose evaluation as the information for evaluating the size of the purchased footwear. Furthermore, for example, the determination section 132 determines proposal content for proposing the evaluation as the information for evaluating the size of the purchased footwear. Furthermore, for example, the determination section 132 determines evaluation weighting as the information for evaluating the size of the purchased footwear.

When the attribute of the user meets a predetermined condition, the determination section 132 determines the evaluation information evaluated within a first valid period after the purchase of the footwear as the evaluation result. Furthermore, when the attribute of the user does not meet the predetermined condition, the determination section 132 determines the evaluation information evaluated within a second valid period after the purchase of the footwear as the evaluation result. For example, when the attribute of the user does not meet the predetermined condition, the determination section 132 determines the evaluation information evaluated within the first period as the evaluation result.

The determination section 132 determines the foot development pattern to apply to the user. For example, the determination section 132 compares the attribute of the user at the first timing with predetermined statistical data of the foot development pattern to determine the foot development pattern to apply to the user at the first timing. For example, the determination section 132 compares the attribute of the user at the first timing with the statistical data of the foot development pattern acquired by the acquisition section 131 to determine the foot development pattern to apply to the user at the first timing.

### (Estimation Section 133)

The estimation section 133 estimates a time period taken until the foot size of the user meets a predetermined condition based on the measurement information acquired by the acquisition section 131 and the foot development pattern determined by the determination section 132. For example, the estimation section 133 estimates the first period based on the measurement information at the first timing and the foot development pattern based on the attribute of the user at the first timing.

The estimation section 133 estimates the time period taken until the foot size of the user meets the predetermined condition based on the foot development pattern obtained by applying the weighting according to the development speed of the individual user to the foot development pattern determined by the determination section 132.

### (Decision Section 134)

The decision section 134 decides whether the attribute of the user meets the predetermined condition. For example, the decision section 134 decides whether the age of the user is 20 years or older.

When the decision section 134 decides that the attribute of the user meets the predetermined condition, the decision section 134 decides whether the evaluation has been made within the first valid period. Furthermore, when the decision section 134 decides that the evaluation has been made within the first valid period, the decision section 134 decides to determine the evaluation information evaluated within the first valid period as the evaluation result. On the contrary, when the decision section 134 does not decide that the evaluation has been made within the first valid period, the decision section 134 decides not to determine the evaluation information as the evaluation result.

When the decision section 134 decides that the attribute of the user does not meet the predetermined condition, the decision section 134 decides whether the evaluation has been made within the second valid period. Furthermore, when the decision section 134 decides that the evaluation has been made within the second valid period, the decision section 134 decides to determine the evaluation information evaluated within the second valid period as the evaluation result. On the contrary, when the decision section 134 does not decide that the evaluation has been made within the second valid period, the decision section 134 decides not to determine the evaluation information as the evaluation result.

The decision section 134 decides whether the user has re-measured the feet. For example, the decision section 134 decides whether the user has re-measured the feet based on whether new measurement information has been acquired. Furthermore, when the decision section 134 decides that the user has re-measured the feet, the decision section 134 decides to determine the timing of the remeasurement of the feet by the user as the timing to propose the evaluation.

The decision section 134 decides whether the user has accessed again a predetermined online mall that provides the footwear purchased by the user. For example, the decision section 134 decides whether the user has accessed again the predetermined online mall that provides the footwear purchased by the user based on a login history to the predetermined online mall. Furthermore, when the decision section 134 decides that the user has accessed again the predetermined online mall that provides the footwear purchased by the user, the decision section 134 decides to determine the timing of the re-access to the predetermined online mall as the timing to propose the evaluation.

The decision section 134 decides a deviation degree between the attribute of the user and the attribute of the predetermined condition. Furthermore, the decision section 134 decides that an evaluation weight is smaller as the decision section decides the deviation degree between the attribute of the user and the attribute of the predetermined condition to be larger. In other words, the decision section 134 decides that the evaluation weight is smaller as the attribute of the user deviates more from the attribute of the predetermined condition.

The decision section 134 decides a deviation degree between the timing of the proposal for the evaluation or the purchase of the footwear and the timing of the evaluation. Furthermore, the decision section 134 decides that the evaluation weight is smaller as the decision section decides the deviation degree between the timing of the proposal for the evaluation or the purchase of the footwear and the timing of the evaluation to be larger. In other words, the decision section 134 decides that the evaluation weight is smaller as the time period taken before the evaluation is longer.

The decision section 134 decides whether the time period taken until the foot size of the user meets the predetermined condition has passed. For example, the decision section 134 decides whether the first period has passed. When the decision section 134 decides that the first period has passed, the decision section 134 decides to terminate the proposal of the footwear based on the measurement information at the first timing.

The decision section 134 decides whether to perform the processing for terminating the proposal depending on the attribute of the user. For example, when the decision section 134 decides that the attribute of the user meets the predetermined condition, the decision section 134 decides not to perform the processing for terminating the proposal. On the contrary, when the decision section 134 decides that the age of the user does not meet the predetermined condition, the decision section 134 decides to perform the processing for terminating the proposal.

The decision section 134 decides whether a number of times of measurement of the foot size of the user meets a predetermined condition. Furthermore, when the decision section 134 decides that the number of times of measurement meets the predetermined condition, the decision section 134 decides to determine the foot development pattern.

### (Provision Section 135)

The provision section 135 provides (transmits) information for proposing the footwear in a size suitable for the foot development. For example, the provision section 135 provides the information for proposing the footwear in the size suitable for the foot development based on the evaluation result based on the information determined by the determination section 132.

The provision section 135 provides information for proposing the evaluation. For example, the provision section 135 provides the information for proposing the evaluation at the timing determined by the determination section 132. Furthermore, for example, the provision section 135 provides the information for proposing the evaluation with the content determined by the determination section 132.

The provision section 135 provides the information for proposing the footwear in the size suitable for the foot development of the user based on an estimation result by the estimation section 133. The provision section 135 provides the information for proposing the footwear in a size larger than the size of the footwear corresponding to the foot size based on the measurement information at an arbitrary timing.

The provision section 135 provides the information for proposing the same footwear in a different size or the footwear of the same brand as the footwear proposed or purchased at an arbitrary timing.

The provision section 135 provides information on an incentive to be provided for the user who has purchased the proposed footwear. For example, the provision section 135 provides information on beneficial treatment for the user who has purchased the proposed footwear within a predetermined time period after the proposal.

The provision section 135 provides information for proposing replacement purchase that includes releasing the footwear purchased at an arbitrary timing and purchasing the proposed footwear. Furthermore, the provision section 135 provides information on beneficial treatment for the user who has made the replacement purchase to replace the proposed footwear within a predetermined time period after the proposal.

The provision section 135 performs processing for not providing the information for proposing the footwear based on the measurement information of the foot size of the user at an arbitrary timing. For example, the provision section 135 provides the information for terminating the proposal of the footwear based on the measurement information of the foot size of the user at an arbitrary timing.

The provision section 135 notifies that the footwear specified for purchase is inappropriate. For example, the provision section 135 notifies that the size is not suitable when the same size as the footwear size based on the measurement information of the foot size of the user at an arbitrary timing is specified.

### 5. Configuration of Management Server

Next, a configuration of the management server 200 according to the embodiment is described with reference to FIG. 9. FIG. 9 is a diagram illustrating a configuration example of the management server 200 according to the embodiment. As shown in FIG. 9, the management server 200 includes a communication section 210, a storage section 220, and a control section 230. The management server 200 may include an input section for receiving various operations from an administrator of the management server 200, or a display section for displaying various information.

### (Communication Section 210)

The communication section 210 is implemented by an NIC or the like, for example. The communication section 210 is connected to a network N by wired or wireless to transmit and receive information to/from the information processing apparatus 100 or the like via the network N.

### (Storage Section 220)

The storage section 220 is implemented, for example, by a semiconductor memory element such as a RAM or a flash memory, or a storage device such as a hard disk or an optical disk.

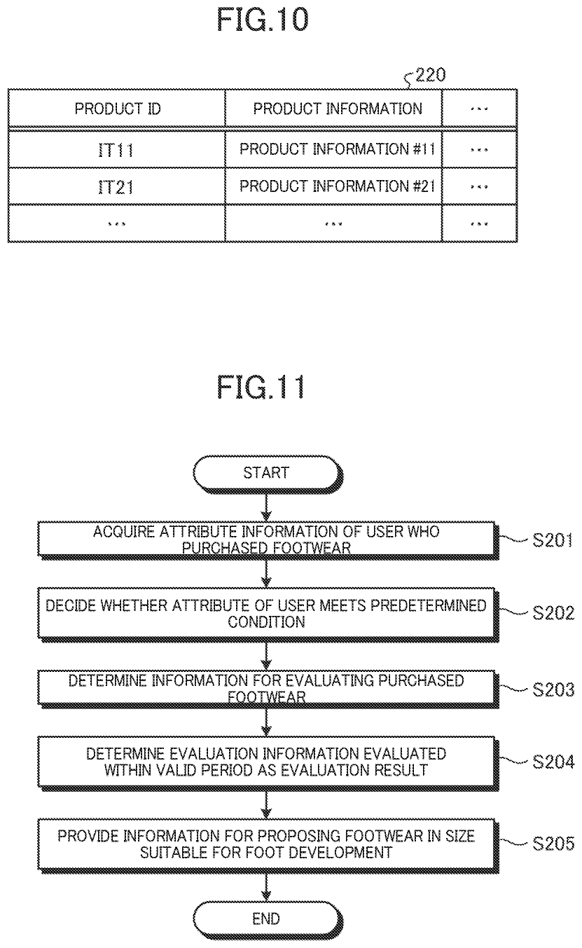

The storage section 220 stores product information on products provided at a predetermined online mall. Here, FIG. 10 shows an example of the storage section 220 according to the embodiment. As shown in FIG. 10, the storage section 220 includes items such as “product ID” and “product information”.

The “product ID” indicates identification information for identifying the product provided at the predetermined online mall. The “product information” indicates the product information of the product provided at the predetermined online mall. Although FIG. 10 shows examples where conceptual information such as “product information #11” or “product information #21” is stored in the “product information”, information such as “brand: A1, size: 13 cm, 13.5 cm, 14 cm, 14.5 cm . . . ” is stored in practice.

That is, FIG. 10 shows an example where the product information identified by the product ID “IT11” is “product information #11”.

### (Control Section 230)

The control section 230 is a controller, and is implemented, for example, by a CPU, an MPU, or the like that executes various programs stored in a storage device embedded in the management server 200 using a RAM as a work area. Furthermore, the control section 230 is a controller, and is implemented by an integrated circuit such as an ASIC or an FPGA, for example.

As shown in FIG. 9, the control section 230 includes an acquisition section 231 and a provision section 232, and implements or executes functions of information processing described below. An internal configuration of the control section 230 is not limited to the configuration shown in FIG. 9, and may be any other configuration if it can perform the information processing described later.

### (Acquisition Section 231)

The acquisition section 231 acquires various information. The acquisition section 231 acquires the various information from external information processing apparatuses. The acquisition section 231 acquires the various information from other information processing apparatuses such as the information processing apparatus 100.

The acquisition section 231 acquires the various information from the storage section 220. The acquisition section 231 also stores the acquired various information into the storage section 220.

The acquisition section 231 acquires the product information on the products provided at the predetermined online mall.

### (Provision Section 232)

The provision section 232 provides (transmits) information acquired by the acquisition section 231. For example, in response to a request for providing the product information received from the information processing apparatus 100, the provision section 232 transmits the product information of the corresponding product to the information processing apparatus 100.

### 6. Information Processing Flow

Next, a process of the information processing by the information processing system 1 according to the embodiment is described with reference to FIG. 11. FIG. 11 is a flowchart illustrating the process of the information processing by the information processing system 1 according to the embodiment.

As shown in FIG. 11, the information processing apparatus 100 acquires attribute information of a user who has purchased footwear in a size suitable for foot development (step S201).

The information processing apparatus 100 decides whether the attribute of the user included in the acquired attribute information meets a predetermined condition (step S202).

The information processing apparatus 100 determines information for evaluating a size of the purchased footwear based on a decision result (step S203).

The information processing apparatus 100 determines evaluation information evaluated within a valid period according to the decision result as an evaluation result (step S204).

The information processing apparatus 100 provides information for proposing footwear in a size suitable for the foot development based on the evaluation result (step S205).

### 7. Advantageous Effects

As described above, an information processing apparatus 100 according to the embodiment includes an acquisition section 131, a determination section 132, and a provision section 135. The acquisition section 131 acquires attribute information of the user who has purchased footwear in a size suitable for the foot development. The determination section 132 determines information for evaluating the size of the purchased footwear based on the attribute of the user included in the attribute information acquired by the acquisition section 131. The provision section 135 provides information for proposing footwear in a size suitable for the foot development based on an evaluation result based on the information determined by the determination section 132.

As a result, the information processing apparatus 100 according to the embodiment can properly perform evaluation of the footwear size in consideration of the foot development.

Furthermore, when the attribute of the user meets a predetermined condition, the determination section 132 determines an evaluation result evaluated within a predetermined time period after the purchase of the footwear as the evaluation result.

When the attribute of the user does not meet the predetermined condition, the determination section 132 determines an evaluation result evaluated within a time period shorter than the predetermined time period after the purchase of the footwear as the evaluation result.

As a result, the information processing apparatus 100 according to the embodiment can more properly perform the evaluation of the footwear size in consideration of the foot development even when the user is a child, for example, based on a comparison between the attribute of the user and an attribute of the predetermined condition.

Furthermore, when the attribute of the user does not meet the predetermined condition, the determination section 132 determines an evaluation result evaluated within a first period estimated to be taken until the foot size of the user meets a predetermined condition as the evaluation result.

As a result, the information processing apparatus 100 according to the embodiment can properly perform the evaluation of the footwear size in consideration of the foot development even when the user is a child, for example, according to the estimation result of the first period.

Furthermore, the determination section 132 determines an evaluation result evaluated within the first period estimated based on a foot development pattern applied with weighting according to development speed of the individual user as the evaluation result.

As a result, the information processing apparatus 100 according to the embodiment can properly perform the evaluation of the footwear size in consideration of the foot development even when the user is a child, for example, according to the development speed of the individual user.

Furthermore, the determination section 132 determines a timing to propose the evaluation as the information for evaluating the size of the purchased footwear. Furthermore, the provision section 135 provides the information for proposing the evaluation at the timing.

As a result, the information processing apparatus 100 according to the embodiment can properly determine the timing to propose the evaluation for properly performing the evaluation of the footwear size in consideration of the foot development.

Furthermore, when the attribute of the user meets the predetermined condition, the determination section 132 determines a timing when the user has re-measured the feet as the timing. When the attribute of the user does not meet the predetermined condition, the determination section 132 does not determine it as the timing.

As a result, the information processing apparatus 100 according to the embodiment can properly determine the timing when the user has re-measured the feet as the timing to propose the evaluation.

Furthermore, when the attribute of the user does not meet the predetermined condition, the determination section 132 determines a timing when the user has accessed a predetermined online mall that provides the purchased footwear as the timing.

As a result, the information processing apparatus 100 according to the embodiment can properly determine the timing when the user has accessed the predetermined online mall that provides the footwear purchased by the user as the timing to propose the evaluation.

Furthermore, when delivery status of the purchased footwear is available, and the attribute of the user does not meet the predetermined condition, the determination section 132 determines a timing when the delivery has been completed as the timing.

As a result, the information processing apparatus 100 according to the embodiment can properly determine the timing when the footwear purchased by the user has been delivered as the timing to propose the evaluation.

Furthermore, the determination section 132 determines proposal content for proposing the evaluation as the information for evaluating the size of the purchased footwear.

As a result, the information processing apparatus 100 according to the embodiment can properly determine the proposal content for proposing the evaluation for properly performing the evaluation of the footwear size in consideration of the foot development.

Furthermore, the determination section 132 determines evaluation weighting as the information for evaluating the size of the purchased footwear.

As a result, the information processing apparatus 100 according to the embodiment can properly determine the evaluation weighting for properly performing the evaluation of the footwear size in consideration of the foot development.

Furthermore, when the attribute of the user does not meet the predetermined condition, the determination section 132 determines the weighting such that an evaluation weight decreases as the attribute deviates more from the attribute of the predetermined condition.

As a result, the information processing apparatus 100 according to the embodiment can properly determine the evaluation weighting based on a comparison between the attribute of the user and the attribute of the predetermined condition for properly performing the evaluation.

Furthermore, when the attribute of the user does not meet the predetermined condition, the determination section 132 determines the evaluation weighting such that the evaluation weight decreases as a time period taken before the evaluation is made extends longer after the information for proposing the evaluation is provided.

As a result, the information processing apparatus 100 according to the embodiment can properly determine the evaluation weighting according to the time period taken before the evaluation is made for properly performing the evaluation.

### 8. Hardware Configuration

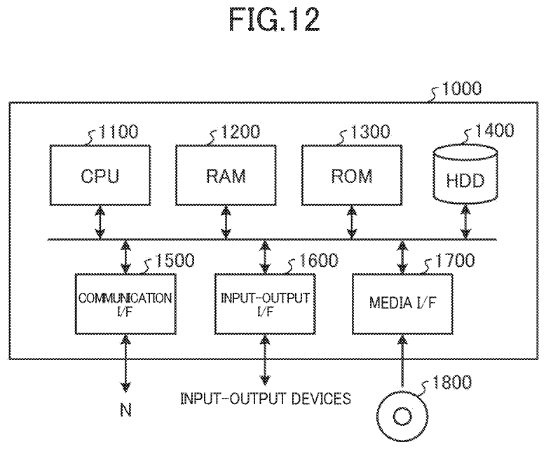

Furthermore, the terminal apparatus 10, the information processing apparatus 100, and the management server 200 according to the embodiment as described above are implemented by a computer 1000 having a configuration shown in FIG. 12, for example. FIG. 12 is a diagram illustrating a hardware configuration of an example of the computer implementing functions of the terminal apparatus 10, the information processing apparatus 100, and the management server 200. The computer 1000 includes a CPU 1100, a RAM 1200, a ROM 1300, an HDD 1400, a communication interface (I/F) 1500, an input-output interface (I/F) 1600, and a media interface (I/F) 1700.

The CPU 1100 operates based on programs stored in the ROM 1300 or the HDD 1400 to control respective sections. The ROM 1300 stores a boot program executed by the CPU 1100 to boot the computer 1000, programs dependent on the hardware of the computer 1000, or the like.

The HDD 1400 stores programs executed by the CPU 1100, data used by these programs, or the like. The communication interface 1500 receives data from other devices via a predetermined communication network to transmit the data to the CPU 1100, and transmits data generated by the CPU 1100 to other devices via the predetermined communication network.

The CPU 1100 controls an output device such as a display or a printer, and an input device such as a keyboard or a mouse via the input-output interface 1600. The CPU 1100 acquires data from the input device via the input-output interface 1600. Furthermore, the CPU 1100 outputs the generated data to the output device via the input-output interface 1600.

The media interface 1700 reads out programs or data stored in a recording medium 1800, and provides the programs or data to the CPU 1100 via the RAM 1200.

The CPU 1100 loads these programs from the recording medium 1800 to the RAM 1200 via the media interface 1700, and executes the loaded programs. The recording medium 1800 includes, for example, an optical recording medium such as a digital versatile disc (DVD) or a phase-change-rewritable disk (PD), a magneto-optical recording medium such as a magneto-optical (MO) disk, a tape medium, a magnetic recording medium, a semiconductor memory, or the like.

For example, when the computer 1000 functions as the terminal apparatus 10, the information processing apparatus 100, and the management server 200 according to the embodiment, the CPU 1100 of the computer 1000 executes the programs loaded on the RAM 1200 to implement functions of the control sections 14, 130, and 230. Although the CPU 1100 of the computer 1000 reads out these programs from the recording medium 1800 to execute, the computer may acquire these programs from other devices via a predetermined network, as an alternative example.

### 9. Others

Furthermore, among the processing described in the embodiment above, the processing described to be performed automatically can be entirely or partly performed manually, or the processing described to be performed manually can be entirely or partly performed automatically by known methods. Moreover, the processing processes, specific names, information including various data or parameters described or shown in the foregoing description or drawings can be changed arbitrarily unless otherwise specified. For example, various information shown in the drawings is not limited to the information shown in the drawings.

Furthermore, the components of the apparatuses shown in the drawings are function concepts, and do not have to be physically configured as shown in the drawings. That is, a specific form of dispersion/integration of the apparatuses is not limited to the forms shown in the drawings, and the apparatuses can be entirely or partly configured to be functionally or physically dispersed/integrated in any unit according to various loads, usage conditions, or the like.

Furthermore, the embodiments described above can be combined as appropriate within a range not causing any contradiction in the processing content.

As described above, some of the embodiments of the present application have been described in detail based on the drawings, but these are examples, and the present disclosure can be implemented in other modes that have been modified and improved in various ways based on the knowledge of those skilled in the art, including the aspects described in the section of the summery of the invention.

Furthermore, the “section”, “module”, or “unit” described above can be read as a “means” or “circuit”. For example, the acquisition section can be read as an acquisition means or an acquisition circuit.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. An information processing apparatus comprising at least one processor or circuit comprising:
an acquisition section configured to acquire attribute information of a user that has purchased footwear in a size suitable for foot development;
a determination section configured to determine information for evaluating the size of the purchased footwear based on an attribute of the user included in the attribute information acquired by the acquisition section; and
a provision section configured to provide information for proposing footwear in a size suitable for the foot development based on an evaluation result based on the information determined by the determination section.

2. The information processing apparatus according to claim 1, wherein
when the attribute of the user meets a predetermined condition, the determination section determines an evaluation result evaluated within a predetermined time period after purchase of the footwear as the evaluation result, and when the attribute of the user does not meet the predetermined condition, the determination section determines an evaluation result evaluated within a time period shorter than the predetermined time period after the purchase of the footwear as the evaluation result.

3. The information processing apparatus according to claim 1, wherein
when the attribute of the user does not meet the predetermined condition, the determination section determines an evaluation result evaluated within a first period estimated to be taken until a foot size of the user meets a predetermined condition as the evaluation result.

4. The information processing apparatus according to claim 3, wherein
the determination section determines an evaluation result evaluated within the first period estimated based on a foot development pattern applied with weighting according to development speed of an individual user as the evaluation result.

5. The information processing apparatus according to claim 1, wherein
the determination section determines a timing to propose evaluation as the information for evaluating the size of the purchased footwear, and
the provision section provides information for proposing the evaluation at the timing.

6. The information processing apparatus according to claim 5, wherein
when the attribute of the user meets the predetermined condition, the determination section determines a timing when the user has re-measured his/her feet as the timing, and when the attribute of the user does not meet the predetermined condition, the determination section does not determine the timing as the timing.

7. The information processing apparatus according to claim 5, wherein
when the attribute of the user does not meet the predetermined condition, the determination section determines a timing when the user has accessed a predetermined online mall that provides the purchased footwear as the timing.

8. The information processing apparatus according to claim 5, wherein
when delivery status of the purchased footwear is available, and the attribute of the user does not meet the predetermined condition, the determination section determines a timing when delivery has been completed as the timing.

9. The information processing apparatus according to claim 1, wherein
the determination section determines proposal content for proposing the evaluation as the information for evaluating the size of the purchased footwear.

10. The information processing apparatus according to claim 1, wherein
the determination section determines the weighting of the evaluation as the information for evaluating the size of the purchased footwear.

11. The information processing apparatus according to claim 10, wherein
when the attribute of the user does not meet the predetermined condition, the determination section determines the weighting such that a weight of the evaluation decreases as the attribute deviates more from an attribute of the predetermined condition.

12. The information processing apparatus according to claim 10, wherein
when the attribute of the user does not meet the predetermined condition, the determination section determines the weighting such that the weight of the evaluation decreases as a time period taken before the evaluation is made extends longer after the information for proposing the evaluation is provided.

13. An information processing method executed by a computer, the method comprising:
an acquisition step for acquiring attribute information of a user that has purchased footwear in a size suitable for foot development;
a determination step for determining information for evaluating the size of the purchased footwear based on an attribute of the user included in the attribute information acquired in the acquisition step; and
a provision step for providing information for proposing footwear in a size suitable for the foot development based on an evaluation result based on the information determined in the determination step.
